(19) United States
(12) Patent Application Publication
(10) Pub. No.: US 2002/0091493 A1
(43) Pub. Date: Jul. 11, 2002

(54) Apparatus and a method for determining an electrical state of a pushbutton switch in an electronic system

(76) Inventors: Gary L. Christopher, Fox River Grove, IL (US); Eric Fritz, Schaumburg, IL (US)

Correspondence Address: MOTOROLA, INC., 1303 East Algonquin Road, Schaumburg, IL, 60196, US

(21) Appl. No.: 09/755,329

(22) Filed: Jan. 5, 2001

(51) Int. Cl. G06F 19/00

(52) U.S. Cl. 702/113

(57) ABSTRACT

A telematics communication system (100) for an automotive vehicle includes a telematics control unit (104) electrically coupled to a pushbutton switch assembly (123) via a wire (136) routed in the automotive vehicle. The telematics control unit (104) includes a signal generator (117) and a signal monitoring circuit (106). The pushbutton switch assembly (123) includes a pushbutton switch (124) electrically coupled in parallel to a capacitor (125). The signal generator (117) generates a test signal (129) in the form of a digital pulse signal. The digital pulse signal travels from the telematics control unit (101) over the wire (136) to the pushbutton switch assembly (123) to change an electrical charge on the capacitor (125). A change of the electrical charge on the first capacitor (125) over time generates a detect signal (153) representative of the electrical state of the pushbutton switch (124). The signal monitoring circuit (106) monitors detect signal (153) relative to various predetermined amplitudes (407 and 409) at various predetermined times (406, 408 and 410) to determine the electrical state of the pushbutton switch (124) and of the wire (136). The electrical state of the pushbutton switch (124) comprises normal operating states including an idle state (401) and an active state (403) and a failure state including a short circuit state (404). The pushbutton switch (124) is not actuated in the idle state (401), is momentarily actuated in the active state (403), and stays actuated in the short circuit state (404). The electrical state of the wire (136) comprises a failure state including an open circuit state (402) and a short circuit state (404).

### FIELD OF THE INVENTION

The present invention relates generally to electronic systems having pushbutton switches for use as input signal devices, and more particularly to an apparatus and a method for determining an electrical state of a pushbutton switch in an electronic system, such as a telematics communication system.

### BACKGROUND OF THE INVENTION

Electronic systems, such as telematics communication systems, typically include a processor and switches. The switches are electrically coupled to the processor to provide input signals to the processor.

In a telematics communication system, the processor is typically located in a discrete location in an automotive vehicle. The discrete location is sometimes referred to as an embedded location. Such discrete locations include, without limitation, near an engine, under a dashboard, under or behind a passenger seat, in a trunk compartment, and the like.

In a telematics communication system, the switches are typically located at a remote position relative to the processor. The switch is typically located in a passenger compartment of the automotive vehicle, such as on a dashboard, on a steering wheel, on a ceiling, and the like. The switch is electrically coupled to the processor from the remote position by using an electrically conductive path, such as a wire. Typically, the switch is implemented as a pushbutton switch.

The pushbutton switch is sometimes used as an emergency call button in a telematics communication system. When a passenger in the automotive vehicle pushes the emergency call button, a signal is transmitted over a radio frequency by the telematics communication system to a remote service center. Personnel at the service center respond to the signal received by contacting the passenger in the vehicle or by dispatching emergency personnel to a determined location of the automotive vehicle.

When the pushbutton switch is used as an emergency call button, it is important that the emergency call button work properly by sending an input signal to the processor when a passenger pushes the emergency call button. Sometimes the pushbutton switch or the wire connecting the pushbutton switch to the processor electrically fails due to poor manufacturing of the pushbutton switch or the wire, due to environmental conditions in the automotive vehicle, due to improper installation of the pushbutton switch or the wire, and the like.

A conventional telematics communication system uses the processor to determine whether or not a pushbutton switch or a wire has failed by determining an electrical state of the pushbutton switch. Electrical states of the pushbutton switch include failure states and normal operating states. The failure states include: an open circuit state and a short circuit state. The normal operating states include: an idle state and an active state. In the open circuit state, the pushbutton switch or the wire is electrically not conductive when the pushbutton switch or the wire should be electrically conductive. In the short circuit state, the pushbutton switch or the wire is electrically conductive when the pushbutton switch or the wire should not be electrically conductive. In the idle state, the pushbutton switch is functioning properly and a passenger of the automotive vehicle has not pressed the pushbutton switch. In the active state, the pushbutton switch is functioning properly and a passenger of the automotive vehicle has pressed the pushbutton switch.

One known technique for the processor to determine the electrical state of the pushbutton switch is using a resistor-based circuit. In this case, a resistor is connected in parallel with a switch. A first terminal of the resistor is connected to ground. A second terminal of the resistor is connected to a direct current (DC) voltage. An analog to digital (A/D) input port to the processor monitors the DC voltage at the second terminal of the resistor. The processor interprets a low voltage (e.g., 0 V) at the A/D input port as an active state, wherein the switch is pressed or closed. The processor interprets a mid voltage (e.g., 2.5 V) at the A/D input port as an idle state, wherein the switch is not pressed or open. The processor interprets a high voltage (e.g., 5 V) at the A/D input port as a failure state, wherein a wire connecting the switch to the processor is broken or open. However, there are several disadvantages of the resistor-based circuit. The resistor-based circuit draws a steady amount of current that drains a battery power supply even when the electrical system is in a standby or sleep mode. Further, the resistor-based circuit cannot detect a short circuit state, wherein the switch is stuck in a closed position.

Accordingly, there is a need for an apparatus and a method for determining an electrical state of a pushbutton switch in an electronic system, such as a telematics communication system, that draws a relatively low current when the electrical system is in a standby mode, and that can detect the idle, active, open circuit and short circuit states.

### BRIEF DESCRIPTION OF THE DRAWINGS

FIG. 1 illustrates a block diagram of an electronic system, such as a telematics communication system installed in an automotive vehicle, including an apparatus for determining an electrical state of a pushbutton switch, in accordance with a preferred embodiment of the present invention.

FIG. 2 illustrates a flowchart describing a method performed by the apparatus, as illustrated in FIG. 1, for determining an electrical state of the pushbutton switch, in accordance with a preferred embodiment of the present invention.

FIG. 3 illustrates a flowchart describing a method performed by the apparatus, as illustrated in FIG. 1, for comparing an amplitude of a detect signal relative to a plurality of predetermined amplitudes at a plurality of predetermined times, as illustrated in FIG. 2, in accordance with a preferred embodiment of the present invention.

FIG. 4 illustrates a timing diagram for the an apparatus for determining an electrical state of the pushbutton switch, as illustrated in FIG. 1, including a test signal, an idle state, an open circuit state, an active state, and a short circuit state, in accordance with a preferred embodiment of the present invention.

FIG. 5 illustrates a table describing various amplitude levels corresponding to various times for each of the idle state, the open circuit state, the active state, and the short circuit state, as illustrated in FIGS. 3 and 4, in accordance with a preferred embodiment of the present invention.

### DETAILED DESCRIPTION OF A PREFERRED EMBODIMENT

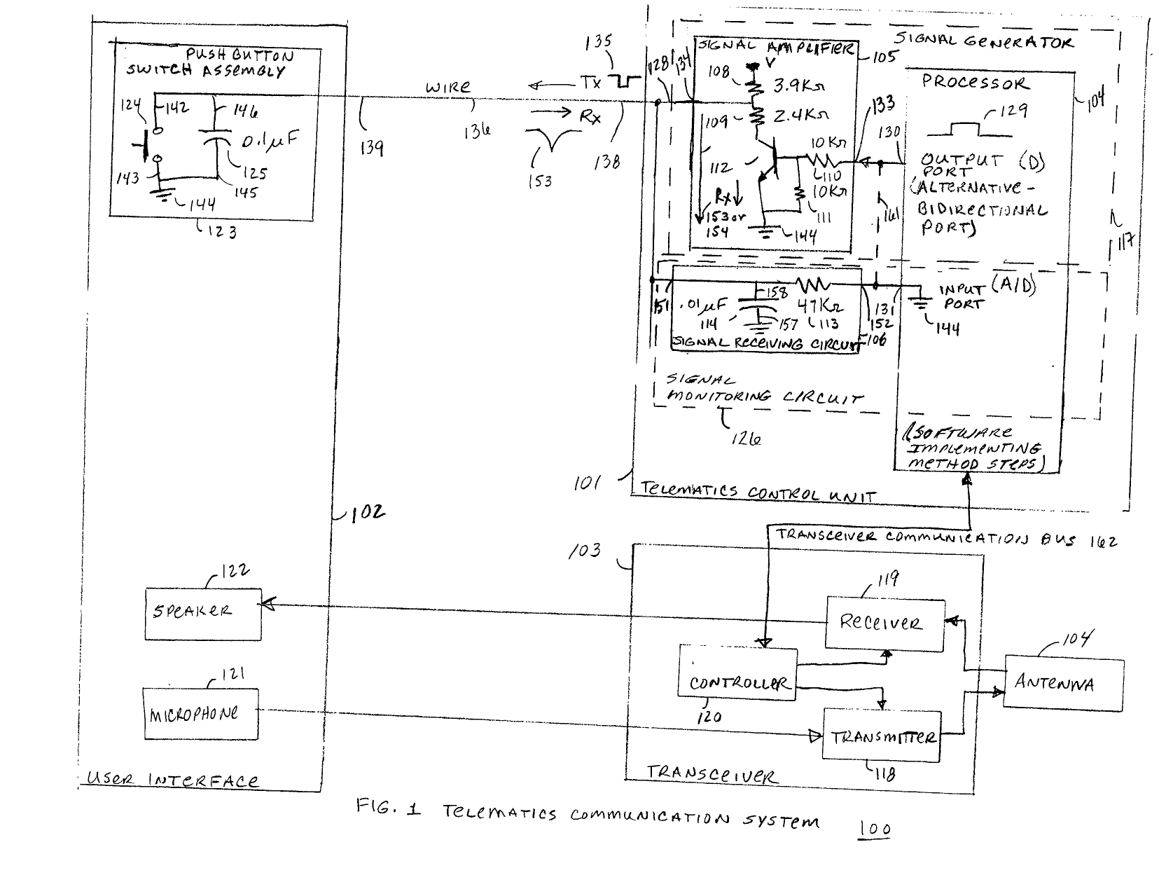

FIG. 1 illustrates a block diagram of an electronic system, such as a telematics communication system 100 installed in an automotive vehicle, including an apparatus 101 and 125 for determining an electrical state of the pushbutton switch 124, in accordance with a preferred embodiment of the present invention.

The automotive vehicle generally includes the telematics communication system 100. The automotive vehicle is preferably a car or a truck, but may be any land, air or water traveled vehicle. Other automotive vehicles include, without limitation, a plane, a boat, a train, a motorcycle, and the like.

The telematics communication system 100 generally includes a telematics control unit 101, a user interface 102, a transceiver 103 and an antenna 104.

The telematics control unit 101 generally includes a processor 104, a signal amplifier 105 and a signal receiving circuit 106. The signal amplifier 105 generally includes resistors 108 (3.9 K ohms), 109 (2.4 K ohms), 110 (10 K ohms), 111 (10 K ohms), and a transistor 112. The signal receiving circuit 106 generally includes a resistor 113 (47 K ohms) and a capacitor 114 (0.01 uF). The signal amplifier 105 in combination with an output port 130 of the processor 104 is referred to as a signal generator 117. The signal receiving circuit 106 in combination with an input port 131 of the processor 104 is referred to as a signal monitoring circuit 126.

The transceiver 103 generally includes a transmitter 118, a receiver 119 and a controller 120.

The user interface 102 generally includes a microphone 121, a speaker 122 and a pushbutton switch assembly 123. The pushbutton switch assembly 123 generally includes a pushbutton switch 124 and a first capacitor 125 (0.1 uF). In the preferred embodiment of the present invention, an apparatus for determining an electrical state of the pushbutton switch 124 generally includes a combination of the telematics control unit 101 and the first capacitor 125.

A wire 136 electrically couples the telematics control unit 101 to the pushbutton switch assembly 123. Preferably, the wire 136 has a connector (not shown) at each end for electrical and mechanical coupling to mating connectors (not shown) at the telematics control unit 101 and at the pushbutton switch assembly 123. The connectors permit convenient installation of the various components in the automotive vehicle.

The transceiver 103 and the telematics control unit 101 are typically integrated into one housing and is typically provided by a cellular telephone manufacturer for installation in a discrete location, such as in a trunk, in a dashboard, or under a seat in a car or truck. Alternatively, the telematics control unit 101 may be in a housing separate from the transceiver 103 and provided by an automotive vehicle manufacturer. Further, automotive design engineers or installation technicians install or integrate the user interface 102 in a discrete location, such as into a dashboard, steering wheel, sun visor or the like of a car or truck. Likewise, automotive design engineers or installation technicians typically install the antenna 104 at a remote position relative to the transceiver 103, such as integrated with a vehicle's entertainment system antenna, integrated with glass (as in a front wind shield), or mounted on a roof of a vehicle.

The telematics control unit 101 is a robust unit well suited to the harsh automotive environment. The telematics control unit 101, which communicates with a central service center (not shown) via the transceiver 103, serves as a central platform where all telematics related technologies are integrated. The telematics control unit 101 communicates location specific information to the central service center and, in turn, the central service center delivers telematics services to a person in the automotive vehicle via the telematics control unit 101. Telematics services include dispatching emergency services, sending roadside assistance, delivering navigation assistance and providing real-time traffic information, among others. The telematics control unit 101 can be connected to an engine control unit (i.e., the on-board computer, not shown) that enables an enhanced service such as remote engine diagnostics.

In addition to the telematics control unit 101, the telematics communication system 100 also includes unique software for various components in the telematics communication system 100. Each component is programmed with software to allow various portions of the telematics communication system 100 to operate as if they were integrated together. For example, software allows a global positioning satellite (GPS) receiver (not shown) and the telematics control unit 101 to interact with one another to relay location information to the central service center, thereby enabling a rendering of services to the automotive vehicle. Other software permits delivery of even more sophisticated communications, including Internet access, information and entertainment on demand, Email, and interaction with e-commerce sites.

Applications for the telematics communication system 100 include: automatic emergency call and response upon airbag deployment, driving directions responsive to a driver's current location, roadside assistance that pinpoints a disabled vehicle, remote control of vehicle's electrical functions such as locking or unlocking doors and stolen vehicle tracking, readily available customer assistance, synchronizing with personal digital assistant (PDA) devices to allow out-of-office information downloads, enhanced service center and network supporting “car meetings” and other tasks, incorporation of real-time traffic information to enhance navigation effectiveness, remote vehicle diagnostics, development of a personal area network permitting seamless integration of the automotive vehicle with other communication and computing platforms including automatic handoff between a hands-free vehicle phone and a portable handset and wireless updates of all calendars, contact lists, etc., synchronization with local merchants and service providers for “push” information and e-commerce, secure access to private data networks, including office e-mail systems, customized information and entertainment on demand including news, financials, weather, sports, audio books, music and games, and over-the-air reprogramming of on-board computer.

The apparatus 101 and 125 for determining an electrical state of pushbutton switch 124 in the telematics communication system 100 is constructed and functions according to the following description. The signal generator 117 has an output terminal 128 and is adapted to generate a test signal 135 at the output terminal 128. In the preferred embodiment of the present invention, the test signal 135 is a digital pulse signal having a predetermined duration (e.g., 50 microseconds) and having a predetermined amplitude (e.g., 5 V). Preferably, the digital pulse signal is a negative digital pulse signal that goes from a high voltage to a low voltage for a period of time then returns to the high voltage. The negative digital pulse signal preferably has a high voltage of 5 V and a low voltage of 0 V, but may also include voltages below 0 V, if it is determined to be favorable to a particular design. Alternatively, digital pulse signal may be a positive digital pulse signal that goes from a low voltage to a high voltage for a period of time then returns to the low voltage. The positive digital pulse signal would preferably have a high voltage of 5 V and a low voltage of 0 V, but may also include voltages below 0 V, if it is determined to be favorable to a particular design. When a positive digital pulse signal is used, an analogous apparatus and analogous methods are used to achieve the same results and the same advantages.

In the preferred embodiment of the present invention, the signal generator 117 generally includes the output port 130 of the processor 104 and the signal amplifier 105. The output port 130 of the processor 104 is adapted to provide the digital pulse signal 129. The signal amplifier 105 has an input terminal 133 and an output terminal 134. The input terminal 133 of the signal amplifier 105 is electrically coupled to the output port 130 of the processor 104 to permit the signal amplifier 105 to receive the digital pulse signal 129. The output terminal 134 of the signal amplifier 105 is the output terminal 128 of the signal generator 117. The signal amplifier 105 is adapted to amplify the digital pulse signal 129 responsive to receiving the digital pulse signal 129 at the input terminal 133 of the signal amplifier 105 to generate an amplified digital pulse signal 135 at the output terminal of the signal amplifier 105. In the preferred embodiment of the present invention, the signal amplifier 105 also inverts the digital pulse signal 129 from a positive digital pulse signal 129 to a negative digital pulse signal 135. Alternatively, the signal amplifier 105 may not invert the digital pulse signal 129, if it is determined to be favorable to a particular design. The signal amplifier 105 is optional depending on the signal driving ability of the processor 104. Further, other signal generating circuitry, such as, without limitation, discrete components or an application specific integrated circuit (ASIC), may be used as an alternative to using the processor 104.

The wire 136 has a predetermined length and includes a first end 138 and a second end 139. The first end 138 of the wire 136 is electrically coupled to the output terminal 128 of the signal generator 117 and adapted to receive and carry the amplified digital pulse signal 135.

The pushbutton switch assembly 123 includes the pushbutton switch 124 and the first capacitor 125. In the preferred embodiment of the present invention, the pushbutton switch 124 is an emergency call pushbutton switch. The pushbutton switch 124 has a first terminal 143 and a second terminal 142. The first terminal 143 of the pushbutton switch 124 is electrically coupled to a ground potential 144. The second terminal 142 of the pushbutton switch 124 is electrically coupled to the second end 139 of the wire 136. The first capacitor 125 has a first terminal 145 and a second terminal 146. The first terminal 145 of the first capacitor 125 is electrically coupled to the ground potential 144. The second terminal 146 of the first capacitor 125 is electrically coupled to the second terminal 142 of the pushbutton switch 124 and electrically coupled to the second end 139 of the wire 136. The second terminal 146 of the first capacitor 125 is electrically coupled to receive the amplified digital pulse signal 135 from the wire 136 to change an electrical charge on the first capacitor 125. Alternatively, a resistor may be electrically coupled in series with the pushbutton switch 124 to reduce a level of an electrical charge or arc across the pushbutton switch 124 when the first capacitor 125 initially discharges responsive to the pushbutton switch 124 being actuated.

A change of the electrical charge on the first capacitor 125 over time generates a detect signal 153 representative of the electrical state of the pushbutton switch 124. In the preferred embodiment of the present invention, the change of the electrical charge on the first capacitor 125 over time is caused by the first capacitor discharging the detect signal 153 through the resistor 109 and the transistor 112 to the ground potential 144 during the presence of the digital pulse signal 135 and caused by the first capacitor charging the detect signal 153 through the resistor 108 to the supply voltage (e.g., 5 V) during the absence of the digital pulse signal 135.

In the preferred embodiment of the present invention, the signal monitoring circuit 126 generally further includes the input port 131 of the processor 104 and the signal receiving circuit 106. The signal receiving circuit 106 has a first terminal 151 and a second terminal 152. The first terminal 151 of the signal receiving circuit 106 is electrically coupled to the output terminal 128 of the signal generator 117. The second terminal 152 of the signal receiving circuit 106 is electrically coupled to the input port 131 of the processor 104. The processor 104 is adapted to monitor the detect signal 153 to determine the electrical state of the pushbutton switch 125. Preferably, the processor monitors the detect signal 153 by monitoring a voltage level on the first capacitor 125 at the input port 131 of the processor 104. Other signal receiving circuitry, such as, without limitation, discrete components including a comparator, or an application specific integrated circuit (ASIC), may be used as an alternative to using the processor 104.

In the preferred embodiment of the present invention, the signal receiving circuit 106 includes a second capacitor 114 having a first terminal 157 and a second terminal 158. The first terminal 157 of the second capacitor 114 is electrically coupled to the ground potential 144. The second terminal 158 of the second capacitor 114 is electrically coupled to the output terminal 128 of the signal generator 117 to permit the second capacitor 114 to be in parallel with the first capacitor 125. The second terminal 158 of the second capacitor 114 is electrically coupled to receive the amplified digital pulse signal 135 from the signal generator 117 to change the electrical charge on the second capacitor 114. A change of the electrical charge on the first capacitor 125 and the second capacitor 114 over time generates the detect signal 153 representative of the electrical state of the pushbutton switch 124 and the wire 136.

In the preferred embodiment of the present invention, the change of the electrical charge on the first capacitor 125 and the second capacitor 114 over time is caused by the first capacitor 125 and the second capacitor 114 discharging the detect signal 153 through the resistor 109 and the transistor 112 to the ground potential 144 during the presence of the digital pulse signal 135 and caused by the first capacitor 125 and the second capacitor 114 charging the detect signal 153 through the resistor 108 to the supply voltage (e.g., 5 V) during the absence of the digital pulse signal 135. The signal monitoring circuit 126 monitors the detect signal 153 to determine the electrical state of the pushbutton switch 124 and the wire 136.

Preferably, the second capacitor 114 also performs an electrostatic discharge (ESD) protection function for the processor 104. Preferably, the signal receiving circuit 106 also includes a resistor 113 (47 K ohms) in series with the input port 131 of the processor 104. Alternatively, the second capacitor 114 and the resistor 113 may be omitted from the signal receiving circuit 106 without substantially affecting the operation of the pushbutton switch and wire diagnostic method. In this case, the diagnostic timing in the software in the processor 104 would need to be adjusted to take into consideration changed timing circumstances due to an absent second capacitor 114.

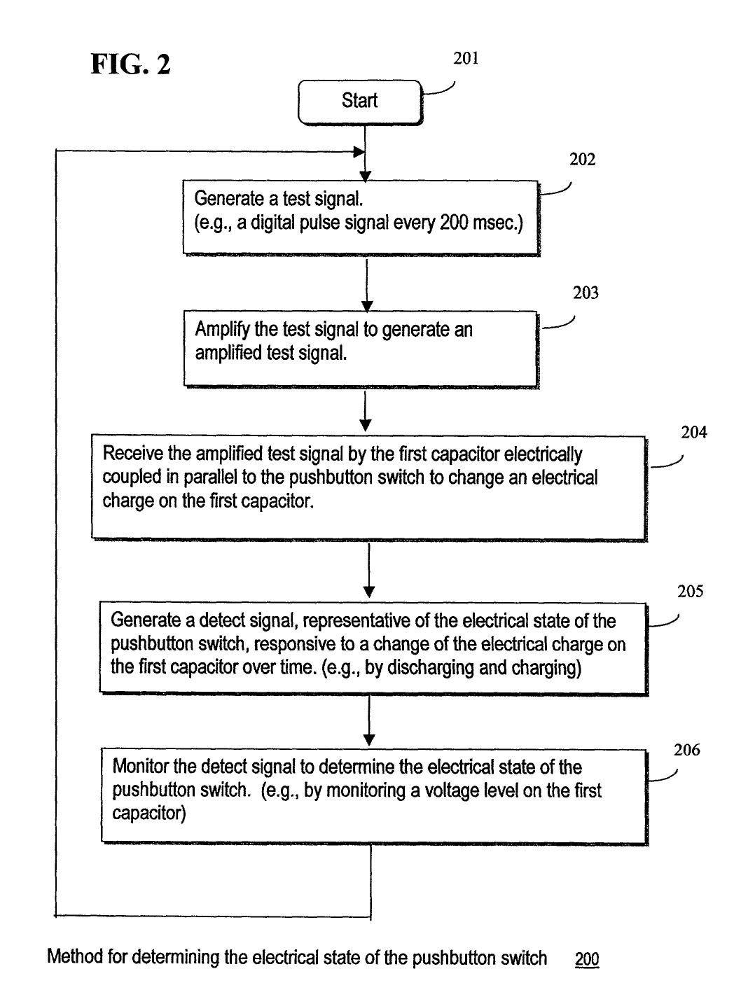

The electrical states of the pushbutton switch 124 preferably comprise normal operating states including an idle state and an active state and a failure state including a short circuit state. The pushbutton switch 124 is not actuated in the idle state. The pushbutton switch 124 is momentarily actuated in the active state. The pushbutton switch 124 stays actuated in the short circuit state. The electrical states of the pushbutton switch 124 are further described with reference to FIGS. 2-5.

The electrical state of the wire 136 preferably comprises failure state including an open circuit state, such as when the wire 136 is broken, and a short circuit state, such as when the wire 136 is shorted to ground. The electrical state of the wire 136 is further described with reference to FIGS. 2-5.

Alternatively, the processor 104 comprises a bi-directional port including the output port 130 of the processor 104 and the input port 131 of the processor 104. The processor 104 provides the digital pulse signal 129 at the bi-directional port configured as the output port 130 of the processor 104 at a first predetermined time. The processor 104 receives the detect signal 153 at the bi-directional port configured as the input port 131 of the processor 104 at a second predetermined time after the first predetermined time. For this configuration, the output terminal of the signal receiving circuit 106 is electrically coupled to the alternative bidirectional port 130 via path 161. In this configuration, a single bi-directional port is advantageously used instead of a dedicated output port and a dedicated input port to conserve on the number of processor ports used to implement the present design. This configuration is possible because it is not necessary for the processor 104 to generate the digital pulse signal 129 and receive the detect signal 153 at the same time. Therefore, the bi-directional port at the processor 104 provides both signal generation and signal monitoring functions for the pushbutton switch 124.

The telematics control unit 101 communicates with the transceiver 103 over a transceiver communication bus 162. The transceiver 103 is coupled to the antenna 104 to transmit and receive radio frequency signals to and from, respectively, a radio frequency base station (not shown). The speaker 122 in the user interface 102 is coupled to the transceiver 103 to convert an electrical input signal to an acoustic output signal. The microphone 121 in the user interface 102 is coupled to the transceiver 103 to convert an acoustic input signal to an electrical output signal. The controller 120 transmits and receives the communications signals over the transceiver communication bus 162. The controller 120 controls the receiver 119, the transmitter 118. The transmitter 118 receives the electrical output signal from the microphone 121, modulates the electrical output signal and transmits the modulated electrical output signal via the antenna 104. The receiver 119 receives a modulated receive signal via the antenna 104, demodulates the modulated receive signal and generates the electrical input signal for the speaker 122.

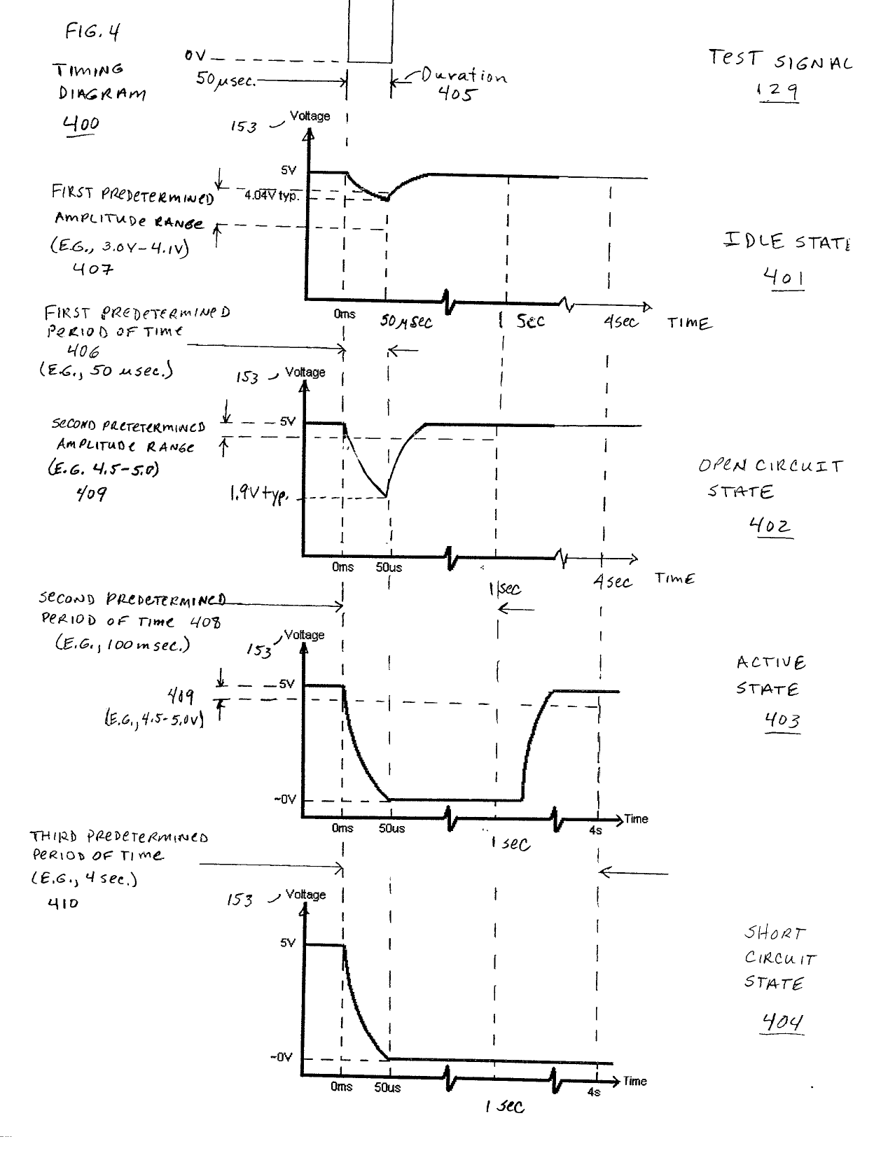

In the preferred embodiment of the present invention, the electrical state of the pushbutton switch 124 may be communicated from the telematics control unit 101 to the transceiver 103 over the transceiver communication bus 162 or be communicated to the passenger in the vehicle using a user interface device, such as an indicator light or an audible tone or speech. When the pushbutton switch 124 is in the idle state 401 (FIG. 4), no communication between the telematics control unit 101 and the transceiver 103 is necessary. When the pushbutton switch 124 is in the open circuit state 402 (FIG. 4) or in the short circuit state 404 (FIG. 4), a failure message may be sent from the telematics control unit 101 to the transceiver 103. The transceiver 103, in turn, notifies a passenger in the automotive vehicle of the failure message, such as, for example and without limitation, by the speaker with a voice activated message or a tone or by an indicator light (not shown). Alternatively, the telematics control unit 101 may notify the passenger of the automotive vehicle directly without going through the transceiver 103. Alternatively, the transceiver 103 may notify the central service center (not shown) having personnel or automated equipment that takes an appropriate action to notify the owner or passenger of the automotive vehicle of the failure, such as, for example and without limitation, by calling the owner or passenger of the automotive vehicle via the transceiver, as is well known in the art. When the pushbutton switch 124 is in the active state 403 (FIG. 4), an active pushbutton switch mode message is sent from the telematics control unit 101 to the transceiver 103. The transceiver 103, in turn, notifies the central service center (not shown) that the pushbutton switch 124 has been actuated. The central service center then responds by calling the passenger in the automotive vehicle or by dispatching personnel to the detected location of the automotive vehicle, as is well known in the art. Other various methods of notification and responses to such notification may be implemented depending on application specific criterions and design preferences.

FIG. 2 illustrates a flowchart describing a method 200 performed by the apparatus, as illustrated in FIG. 1, for determining the electrical state of the pushbutton switch 124, in accordance with a preferred embodiment of the present invention.

At step 201, the method 200 starts.

At step 202, the signal generator 117 generates the test signal 129, as described hereinabove. In the preferred embodiment of the present invention, the test signal 129 formed as a digital pulse signal is generated every 200 milliseconds. This timing is chosen based on a predetermined application specific criterion that the pushbutton switch 124 must be held down for at least 1.0 second. Hence, the test signal generated every 200 milliseconds provides up to five samples of the electrical state of the pushbutton switch within the 1.0 second criterion to confirm the electrical state of the pushbutton switch 124.

At step 203, the signal amplifier 105 amplifies the test signal 129 to generate the amplified test signal 135 responsive to receiving the test signal 129, as described hereinabove. The step 203 of amplifying is optional depending on the drive capability of the output port 130 of the processor 104.

At step 204, the first capacitor 125 receiving the test signal to change the electrical charge on the first capacitor 125, as described hereinabove.

At step 205, the detect signal 153 is generated, representative of the electrical state of the pushbutton switch 124, responsive to a change of the electrical charge on the first capacitor 125 over time, as described hereinabove.

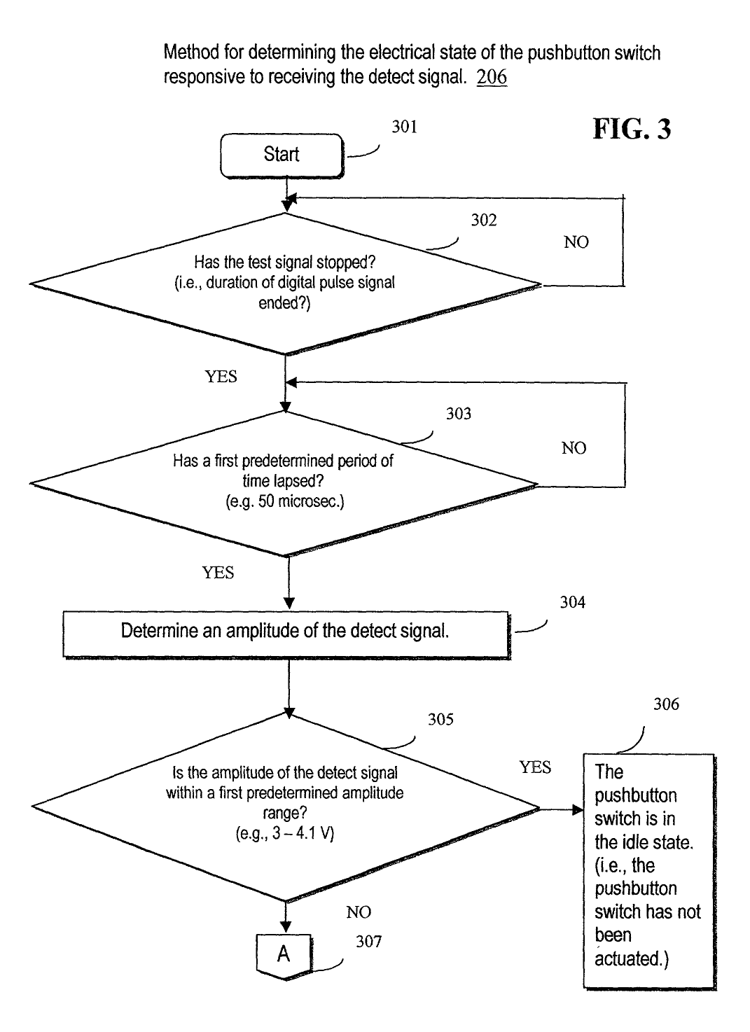

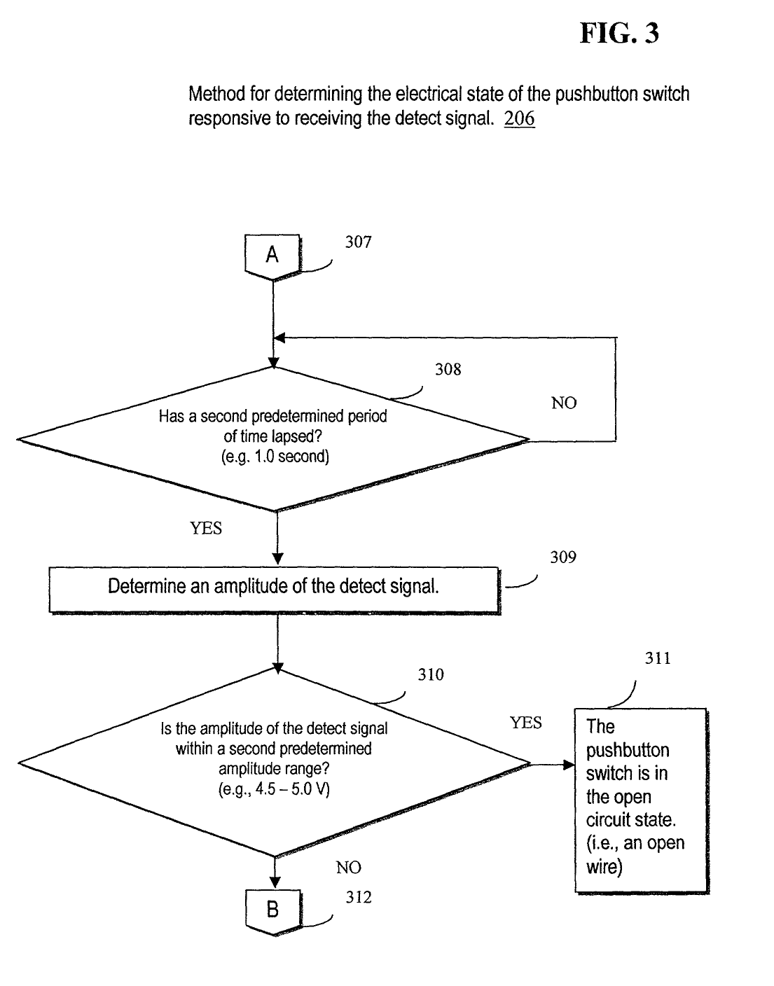

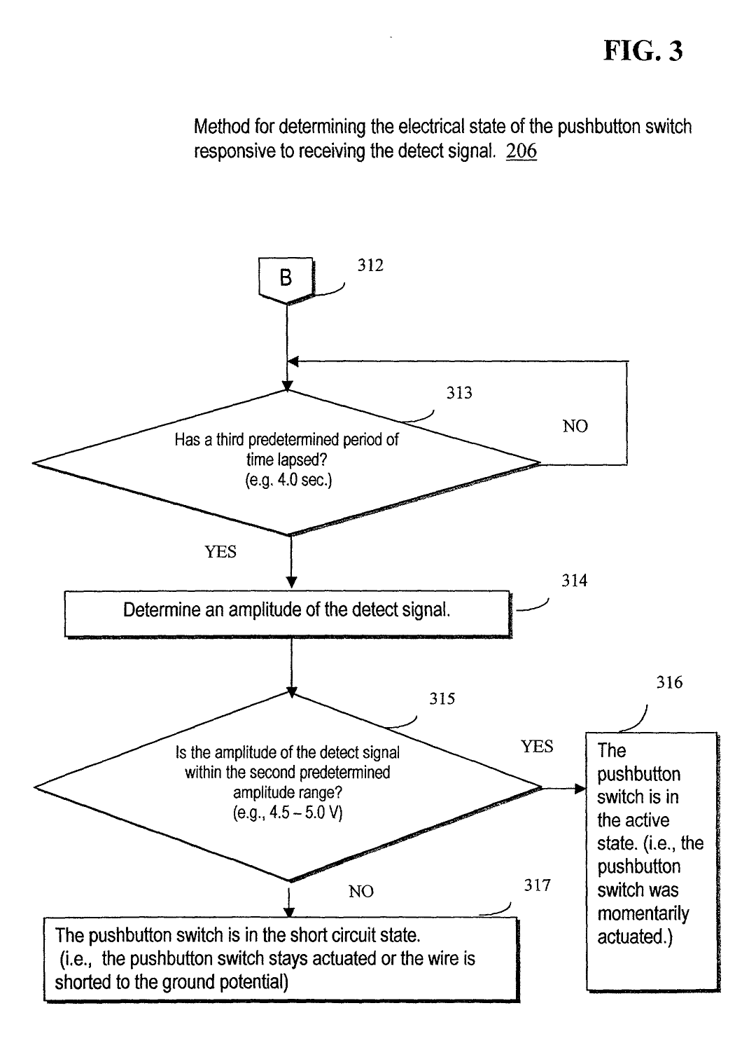

At step 206, the processor 104 monitors the detect signal 153 to determine the electrical state of the pushbutton switch 124, as described hereinabove. In the preferred embodiment of the present invention, the processor 104 implements step 206 by comparing an amplitude of the detect signal 153 relative to a plurality of predetermined amplitudes at a plurality of predetermined times. Essentially, the processor 104 monitors the voltage level on the first capacitor 125 over time, caused by the first capacitor 125 charging and discharging responsive to the digital pulse signal 135, to characterize the various electrical states of the pushbutton switch 124. Step 206 is described in further detail with reference to FIGS. 3, 4 and 5 herein below.

Alternate embodiments of the present invention may include more than one pushbutton switch assembly electrically coupled to the telematics control unit 101 via separate wires. In this case, a signal generator and a signal monitoring circuit may be dedicated for each additional pushbutton switch assembly. Alternatively, circuit synergy may be gained by using only one signal generator 117 and an appropriate switch isolation circuit to prevent an electrical state of one pushbutton switch from being interpreted as an electrical state of another pushbutton switch. In this one signal generator 117 case for two pushbutton switch assemblies, the processor 104 may use two input ports or may use one bi-directional port and one other input port. To determine the electrical state of a second pushbutton switch, the processor 104 implements steps (not shown) that are analogous to steps 204, 205 and 206 in the method 200.

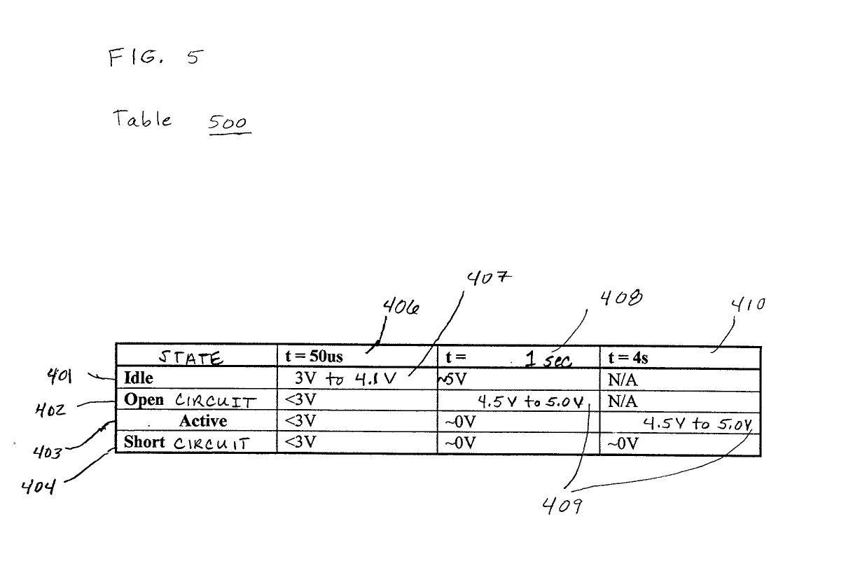

Next, the remaining figures, FIGS. 3, 4 and 5, are described together because they describe the same step 206 (FIG. 2) in further detail from different points of view according to a detailed method of step 206 (FIG. 3), a timing diagram 400 (FIG. 4) and a table 500 (FIG. 5). FIG. 3 illustrates a flowchart describing a method 206 performed by the apparatus, as illustrated in FIG. 1, for comparing an amplitude of the detect signal 153 relative to a plurality of predetermined amplitudes at a plurality of predetermined times, as illustrated in FIG. 2, in accordance with a preferred embodiment of the present invention. FIG. 4 illustrates a timing diagram 400 for the an apparatus for determining an electrical state of the pushbutton switch 124, as illustrated in FIG. 1, including a test signal 129, an idle state 401, an open circuit state 402, an active state 403, and a short circuit state 404, in accordance with a preferred embodiment of the present invention. FIG. 5 illustrates a table 500 describing various amplitude levels corresponding to various times for each of the idle state, the open circuit state, the active state, and the short circuit state, as illustrated in FIGS. 3 and 4, in accordance with a preferred embodiment of the present invention.

At step 301, the method 206 starts.

At step 302, the processor 104 determines whether the test signal 129 has stopped. In the preferred embodiment of the present invention, the test signal is a digital pulse signal having a pulse duration 405 (FIGS. 4 and 5) of 50 microseconds. Other test signals and/or pulse durations may be used depending on specific applications and implementations. The test signal 129 has stopped at the end of the 50 microseconds duration of the digital pulse signal. If the test signal 129 has stopped, then the method continues to step 303. If the test signal 129 has not stopped, then the method returns to the same step 302 and continues to wait for the test signal 129 to stop.

At step 303, the processor 104 determines whether a first predetermined period of time 406 (FIGS. 4 and 5) has lapsed responsive to the step 302 of determining that the test signal 129 has stopped. In the preferred embodiment of the present invention, the first predetermined period of time 406 is 50 microseconds. The first predetermined period of time 406 is dependent on a time constant, determined from the value of the first capacitor 125 and the second capacitor 114 as well as the value of any resistance in series with the ground potential 144, as well as application specific criterion. In the preferred embodiment of the present invention, the time between when the test signal 129 has stopped and when the first predetermined period of time 406 starts is not critical because the duration 405 of the digital pulse signal 129 is 50 microseconds and the digital pulse signal 129 is generated every 200 milliseconds. Therefore, there is plenty of time between successive digital pulse signals to monitor the first predetermined period of time. If the first predetermined period of time has not lapsed, then the method returns to the same step 303 and continues to wait until the first predetermined period of time 406 has lapsed. If the first predetermined period of time 406 has lapsed, then the method continues to step 304.

At step 304, the processor 104 determines an amplitude of the detect signal 153 responsive to the step of determining that the first predetermined period of time 406 has lapsed. In the preferred embodiment of the present invention, the amplitude of the detect signal 153 is a voltage level of the detect signal 153. The processor 104 determines the amplitude of the detect signal 153 by measuring the voltage level of the detect signal 153 present at the input port 132 of the processor 104.

At step 305, the processor 104 determines whether the amplitude of the detect signal 153 is within a first predetermined amplitude range 407 (FIGS. 4 and 5) responsive to the step of determining the amplitude of the detect signal 153. In the preferred embodiment of the present invention, the first predetermined amplitude range 407 is between 3 V and 4.1 V. Other amplitude ranges or amplitude thresholds may be used depending on specific applications or implementations. If the amplitude of the detect signal 153 is not within the first predetermined amplitude range 407, then the method continues to the step 308, via the flowchart continuation block 307. If the amplitude of the detect signal 153 is within the first predetermined amplitude range 407, then the method continues to step 306.

At step 306, the processor 104 determines that the electrical state of the pushbutton switch 124 is in the idle state 401 (FIGS. 4 and 5), indicative of the pushbutton switch 124 not being actuated, responsive to the step 305 of determining that the amplitude of the detect signal 153 is within the first predetermined amplitude range 407. In the preferred embodiment of the present invention, the first predetermined amplitude range 407 is typically determined to be 4.04 V. In the idle state 401, both the first capacitor 125 and the second capacitor 114 partially discharge, responsive to the negative digital pulse signal of the test signal 129, to the typical voltage level of about 4.04 V within the first predetermined amplitude range 407 (e.g., 3.0-4.1 V) after the first predetermined period of time 406 has lapsed. Then after the negative digital pulse signal of the test signal 129 has returned to its high voltage level, both the first capacitor 125 and the second capacitor 114 charge back up to the high voltage level of 5 V. In summary of the idle state, the processor 104 determines that the voltage level of the detect signal 153 is within the first predetermined amplitude range 407 (e.g., 3.0-4.1 V) after a lapse of the first predetermined period of time 406 (50 microseconds). Then, after a lapse of the second predetermined period of time 408 (1.0 second), the processor 104 determines that the voltage level of the detect signal 153 returns to the high voltage level of the test signal 129 (e.g., 5 V). A third determination of the voltage level of the detect signal 153 after the third predetermined period of time 410 (e.g., 4 sec) is not needed for making a positive determination of the idle state.

At step 308, the processor 104 determines whether a second predetermined period of time 408 (FIGS. 4 and 5), longer than the first predetermined period of time 406, has lapsed responsive to the step 305 of determining that the amplitude of the detect signal 153 is not within the first predetermined amplitude range 407. In the preferred embodiment of the present invention, the second predetermined period of time 408 is 1.0 second. The second predetermined period of time is dependent on a time constant, determined from the value of the first capacitor 125 and the second capacitor 114 as well as the value of any resistance in series with the ground potential 144, as well as application specific criterion. If the second predetermined period of time 408 has not lapsed, then the method returns to the same step 308 and continues to wait until second predetermined period of time 408 has lapsed. If the second predetermined period of time 408 has lapsed, then the method continues to step 309.

At step 309, the processor 104 determines the amplitude of the detect signal 153 responsive to the step of determining that the second predetermined period of time 408 has lapsed. In the preferred embodiment of the present invention, the amplitude of the detect signal 153 is a voltage level of the detect signal 153. The processor 104 determines the amplitude of the detect signal 153 by measuring the voltage level of the detect signal 153 present at the input port 131 of the processor 104.

At step 310, the processor 104 determines whether the amplitude of the detect signal 153 is within a second predetermined amplitude range 409 (FIGS. 4 and 5), greater than the first predetermined amplitude range 407, responsive to the step 309 of determining the amplitude of the detect signal 153. In the preferred embodiment of the present invention, the second predetermined amplitude range 409 is between 4.5 V and 5.0 V. Other amplitude ranges or amplitude thresholds may be used depending on a specific application or implementation. If the amplitude of the detect signal 153 is not within the second predetermined amplitude range 409, then the method continues to the step 313, via the flowchart continuation block 312. If the amplitude of the detect signal 153 is within the second predetermined amplitude range 409, then the method continues to step 311.

At step 311, the processor 104 determines that the electrical state of the pushbutton switch 124 is in the open circuit state 402 (FIGS. 4 and 5), indicative of an open circuit in the wire 136 electrically coupled to the pushbutton switch 124, responsive to the step 310 of determining that the amplitude of the detect signal 153 is within the second predetermined amplitude range 409. If the wire 136 is an open circuit, then only the second capacitor 114 is monitored by the signal monitoring circuit 126. The signal monitoring circuit 126 cannot monitor the first capacitor 125 due to the open circuit in the wire 136. In the preferred embodiment of the present invention, the second predetermined amplitude range 409 is typically determined to be 5.0 V. Hence, in the open circuit state 402, only the second capacitor 114 is permitted to discharge and charge responsive to the negative digital pulse signal of the test signal 129. Since the second capacitor 114 is much smaller than the first capacitor 125, the second capacitor 114 is capable of holding a much smaller charge. Hence, when the negative digital pulse signal of the test signal 129 is present, the second capacitor 114 alone discharges more quickly than both the first capacitor 125 and the second capacitor 114 together to a voltage level less than the first predetermined voltage range (e.g., less than 3.0-4.1 V) after the first predetermined period of time 406 has lapsed. In the preferred embodiment of the present invention, the second capacitor 114 discharges to a typical voltage level of 1.9 V. Then, after the second period of time 408 has lapsed when the negative digital pulse signal of the test signal 129 is absent, the second capacitor 114 charges back up to the high voltage level of 5 V permitting the processor 104 to measure the voltage level of the detect signal 153 within the second predetermined amplitude range 409 (e.g., 4.5-5.0 V). In summary of the open circuit state 402, the processor 104 determines that the voltage level of the detect signal 153 is not within the first predetermined amplitude range 407 (e.g., 3.0-4.1 V) after a lapse of the first predetermined period of time 406 (50 microseconds). Then, after a lapse of the second predetermined period of time 408 (1.0 second), the processor 104 determines that the voltage level of the detect signal 153 is within the second predetermined amplitude range 409 (e.g., 4.5-5.0 V). A third determination of the voltage level of the detect signal 153 after the third predetermined period of time 410 (e.g., 4 sec) is not needed for making a positive determination of the idle state.

At step 313, the processor 104 determines whether a third predetermined period of time 410, longer than the second predetermined period of time 408, has lapsed responsive to the step of determining that the amplitude of the detect signal 153 is not within the second predetermined amplitude range 409. In the preferred embodiment of the present invention, the third predetermined period of time 410 is 4.0 second. The third predetermined period of time 410 is dependent on a time constant, determined from the value of the first capacitor 125 and the second capacitor 114 as well as the value of any resistance in series with the ground potential 144, as well as application specific criterion. If the third predetermined period of time 410 has not lapsed, then the method returns to the same step 313 and continues to wait until third predetermined period of time 410 has lapsed. If the third predetermined period of time 410 has lapsed, then the method continues to step 314.

At step 314, the processor 104 determines the amplitude of the detect signal 153 responsive to the step of determining that the third predetermined period of time 410 has lapsed. In the preferred embodiment of the present invention, the amplitude of the detect signal 153 is a voltage level of the detect signal 153. The processor 104 determines the amplitude of the detect signal 153 by measuring the voltage level of the detect signal 153 present at the input port 131 of the processor 104.

At step 315, the processor 104 determines whether the amplitude of the detect signal 153 is within the second predetermined amplitude range 409 responsive to the step of determining the amplitude of the detect signal 153. In the preferred embodiment of the present invention, the second predetermined amplitude range is between 4.5 V and 5.0 V. Other amplitude ranges or amplitude thresholds may be used depending on a specific application or implementation. If the amplitude of the detect signal 153 is not within the second predetermined amplitude range 409, then the method continues to the step 317. If the amplitude of the detect signal 153 is within the second predetermined amplitude range 409, then the method continues to step 316.

At step 316, the processor 104 determines that the electrical state of the pushbutton switch 124 is in the active state 403 (FIGS. 4 and 5) indicative of the pushbutton switch 124 being momentarily actuated responsive to the step of determining that the amplitude of the detect signal 153 is within the second predetermined amplitude range 409. In the preferred embodiment of the present invention, momentary actuation means that a person must hold down the pushbutton switch 124 for at least 1.0 second, but no longer than 4.0 sec. Hence, when the pushbutton switch 124 is momentarily actuated in the active state 403, the first capacitor 125 is momentarily shorted to the ground potential 144, via the pushbutton switch 124, causing the amplitude of the detect signal 153 to be 0 V for at least the second predetermined period of time 408. Then, when the pushbutton switch 124 is released the second terminal 142 of pushbutton switch 124 reaches the high voltage level of 5 V causing the amplitude of the detect signal 153 return to 5 V after the second predetermined period of time 408. A release of the pushbutton switch 124 causes both the first capacitor 124 and the second capacitor 114 to receive the charge from high voltage level (5 V) of the the test signal 129 to permit a substantial amount of the voltage delivered by the test signal 129 (e.g., 5 V) to accumulate on both the first capacitor 124 and the second capacitor 114 (e.g., 4.5-5.0 V) after the third predetermined period of time 410 has lapsed.

At step 317, the processor 104 determines that the electrical state of the pushbutton switch 317 is in the short circuit state 404 (FIGS. 4 and 5), indicative of the pushbutton switch 124 staying actuated, or determines that the wire 136 is being shorted to the ground potential responsive to the step of determining that the amplitude of the detect signal 153 is not within the second predetermined amplitude range. When the pushbutton switch 124 stays actuated in the short circuit state 404, the pushbutton switch 124 is stays shorted to the ground potential 144, via the pushbutton switch 124, causing the amplitude of the detect signal 153 to be 0 V for at least the third predetermined period of time 410. When the wire 136 is shorted to the ground potential in the short circuit state 404 the amplitude of the detect signal 153 is 0 V for at least the third predetermined period of time 410.

The preferred embodiment of the present invention is described using capacitors (i.e., 125 and 114). Alternatively, the present invention may also be implemented with inductors (not shown) instead of capacitors. An inductor would be configured in series with the pushbutton switch rather than in parallel with the pushbutton switch, as with the capacitor. Further, with the inductor, current would be monitored instead of voltage, as with the capacitor. Of course, the current from the inductor may be converted into a voltage drop using resistance for convenient measurement. Hence, the capacitor and the inductor are otherwise called passive energy storage elements. The capacitor implementation is preferred due to the small size of the capacitors, the corresponding relatively low cost, the convenience of measuring voltage, as compared to using an inductor.

In summary of the preferred embodiment of the present invention, the processor 104 advantageously compares the amplitude of a detect signal 153 to the plurality of predetermined amplitudes 407, 409 at the plurality of predetermined times 406, 408 and 410 to determine the electrical state 401, 402, 403, 404 of the pushbutton switch 124. Capacitors 125 and 114 advantageously reduce current drain in the electrical system while providing the method for determining the electrical state 401, 402, 403, 404 of the pushbutton switch 124.

Hence, while the present invention has been described with reference to various illustrative embodiments thereof, the present invention is not intended that the invention be limited to these specific embodiments. Those skilled in the art will recognize that variations and modifications can be made without departing from the spirit and scope of the invention as set forth in the appended claims.

What is claimed is:

1. An apparatus for determining an electrical state of a pushbutton switch in an electronic system, the apparatus comprising:
a signal generator having an output terminal and adapted to generate a test signal at the output terminal;
a pushbutton switch assembly including:
a pushbutton switch having a first terminal and a second terminal, wherein the first terminal of the pushbutton switch is electrically coupled to a ground potential, and wherein the second terminal of the pushbutton switch is electrically coupled to the output terminal of the signal generator; and
a first capacitor having a first terminal and a second terminal, wherein the first terminal of the first capacitor is electrically coupled to the ground potential, wherein the second terminal of the first capacitor is electrically coupled to the second terminal of the pushbutton switch and electrically coupled to the output terminal of the signal generator, wherein the second terminal of the first capacitor is electrically coupled to receive the test signal to change an electrical charge on the first capacitor, and wherein the change of the electrical charge on the first capacitor over time generates a detect signal representative of the electrical state of the pushbutton switch; and
a signal monitoring circuit having an input terminal electrically coupled to receive the detect signal, wherein the signal monitoring circuit is adapted to monitor the detect signal to determine the electrical state of the pushbutton switch.

2. The apparatus according to claim 1, wherein the electrical state of the pushbutton switch further comprises: normal operating states including an idle state and an active state and a failure state including a short circuit state, wherein the pushbutton switch is not actuated in the idle state, and wherein the pushbutton switch is momentarily actuated in the active state, wherein the pushbutton switch stays actuated in the short circuit state.

3. The apparatus according to claim 1, wherein the test signal is a digital pulse signal having a predetermined duration and a predetermined amplitude.

4. The apparatus according to claim 1, further comprising:
a wire having a predetermined length and including a first end and a second end, wherein the first end of the wire is electrically coupled to the output terminal of the signal generator and adapted to receive and carry the test signal, wherein the second end of the wire is electrically coupled to the second terminal of the first capacitor, wherein the change of the electrical charge on the first capacitor over time generates the detect signal representative of the electrical state of the pushbutton switch and the wire.

5. The apparatus according to claim 4, wherein the electrical state of the wire further comprises failure states including an open circuit state and a short circuit state.

6. The apparatus according to claim 4, further comprising:
a second capacitor having a first terminal and a second terminal, wherein the first terminal of the second capacitor is electrically coupled to the ground potential, wherein the second terminal of the second capacitor is electrically coupled to the output terminal of the signal generator to permit the second capacitor to be in parallel with the first capacitor, wherein the second terminal of the second capacitor is electrically coupled to receive the test signal from the signal generator to change the electrical charge on the second capacitor, wherein the change of the electrical charge on the first capacitor and the second capacitor over time generates the detect signal representative of the electrical state of the pushbutton switch and the wire; and
wherein the signal monitoring circuit is adapted to monitor the detect signal to determine the electrical state of the pushbutton switch and the wire.

7. The apparatus according to claim 1, wherein the signal generator further includes:
a processor having an output port and an input port, wherein the output port of the processor is adapted to provide the test signal; and
a signal amplifier having an input terminal and an output terminal, wherein the input terminal of the signal amplifier is electrically coupled to the output port of the processor to permit the signal amplifier to receive the test signal, wherein the output terminal of the signal amplifier is the output terminal of the signal generator, wherein the signal amplifier is adapted to amplify the test signal responsive to receiving the test signal at the input terminal of the signal amplifier to generate an amplified test signal at the output terminal of the signal amplifier.

8. The apparatus according to claim 7 wherein the processor further comprises a bidirectional port including the output port of the processor and the input port of the processor, wherein the processor provides the test signal at the bi-directional port configured as the output port of the processor at a first predetermined time, and wherein the processor monitors the detect signal at the bi-directional port configured as the input port of the processor at a second predetermined time after the first predetermined time.

9. An apparatus for determining an electrical state of a pushbutton switch in an electronic system, the apparatus comprising:
a signal generator having an output terminal and adapted to generate a test signal at the output terminal, wherein the test signal is a digital pulse signal having a predetermined duration and a predetermined amplitude;
a wire having a predetermined length and including a first end and a second end, wherein the first end of the wire is electrically coupled to the output terminal of the signal generator and adapted to receive and carry the digital pulse signal;
a pushbutton switch assembly including:
a pushbutton switch having a first terminal and a second terminal, wherein the first terminal of the pushbutton switch is electrically coupled to a ground potential, and wherein the second terminal of the pushbutton switch is electrically coupled to the second end of the wire; and
a first capacitor having a first terminal and a second terminal, wherein the first terminal of the first capacitor is electrically coupled to the ground potential, wherein the second terminal of the first capacitor is electrically coupled to the second terminal of the pushbutton switch and electrically coupled to the second end of the wire, wherein the second terminal of the first capacitor is electrically coupled to receive the digital pulse signal from the wire to change an electrical charge on the first capacitor, and wherein the change of the electrical charge on the first capacitor over time generates a detect signal representative of the electrical state of the pushbutton switch and the wire; and
a signal monitoring circuit having an input terminal electrically coupled to receive the detect signal, wherein the signal monitoring circuit is adapted to monitor the detect signal to determine the electrical state of the pushbutton switch and the wire.

10. The apparatus according to claim 9:
wherein the electrical state of the pushbutton switch further comprises: normal operating states including an idle state and an active state and a failure state including a short circuit state, wherein the pushbutton switch is not actuated in the idle state, and wherein the pushbutton switch is momentarily actuated in the active state, wherein the pushbutton switch stays actuated in the short circuit state, and
wherein the electrical state of the wire further comprises failure states including an open circuit state and a short circuit state.

11. The apparatus according to claim 9, wherein the signal generator further includes:
a processor having an output port and an input port, wherein the output port of the processor is adapted to provide the digital pulse signal; and
a signal amplifier having an input terminal and an output terminal, wherein the input terminal of the signal amplifier is electrically coupled to the output port of the processor to permit the signal amplifier to receive the digital pulse signal, wherein the output terminal of the signal amplifier is the output terminal of the signal generator, wherein the signal amplifier is adapted to amplify the digital pulse signal responsive to receiving the digital pulse signal at the input terminal of the signal amplifier to generate an amplified digital pulse signal at the output terminal of the signal amplifier.

12. The apparatus according to claim 11, wherein the processor further comprises a bidirectional port including the output port of the processor and the input port of the processor, wherein the processor provides the digital pulse signal at the bidirectional port configured as the output port of the processor at a first predetermined time, and wherein the processor monitors the detect signal at the bidirectional port configured as the input port of the processor at a second predetermined time after the first predetermined time.

13. The apparatus according to claim 9, further comprising:
a second capacitor having a first terminal and a second terminal, wherein the first terminal of the second capacitor is electrically coupled to the ground potential, wherein the second terminal of the second capacitor is electrically coupled to the output terminal of the signal generator to permit the second capacitor to be in parallel with the first capacitor, wherein the second terminal of the second capacitor is electrically coupled to receive the amplified digital pulse signal from the signal generator to change the electrical charge on the second capacitor, and wherein the change of the electrical charge on the first capacitor and the second capacitor over time generates the detect signal representative of the electrical state of the pushbutton switch and the wire, and
wherein the signal monitoring circuit is adapted to monitor the detect signal to determine the electrical state of the pushbutton switch and the wire.

14. An apparatus for determining an electrical state of a pushbutton switch in an electronic system, the apparatus comprising:
a signal generator having an output terminal and adapted to generate a test signal at the output terminal, wherein the test signal is a digital pulse signal having a predetermined duration and a predetermined amplitude, wherein the signal generator further includes:
a processor having an output port and an input port, wherein the output port of the processor is adapted to provide the digital pulse signal; and
a signal amplifier having an input terminal and an output terminal, wherein the input terminal of the signal amplifier is electrically coupled to the output port of the processor to permit the signal amplifier to receive the digital pulse signal, wherein the output terminal of the signal amplifier is the output terminal of the signal generator, wherein the signal amplifier is adapted to amplify the digital pulse signal responsive to receiving the digital pulse signal at the input terminal of the signal amplifier to generate an amplified digital pulse signal at the output terminal of the signal amplifier;
a wire having a predetermined length and including a first end and a second end, wherein the first end of the wire is electrically coupled to the output terminal of the signal generator and adapted to receive and carry the amplified digital pulse signal;
a pushbutton switch assembly including:
a pushbutton switch having a first terminal and a second terminal, wherein the first terminal of the pushbutton switch is electrically coupled to a ground potential, and wherein the second terminal of the pushbutton switch is electrically coupled to the second end of the wire; and
a first capacitor having a first terminal and a second terminal, wherein the first terminal of the first capacitor is electrically coupled to the ground potential, wherein the second terminal of the first capacitor is electrically coupled to the second terminal of the pushbutton switch and electrically coupled to the second end of the wire, and wherein the second terminal of the first capacitor is electrically coupled to receive the amplified digital pulse signal from the wire to change an electrical charge on the first capacitor, and wherein the change of the electrical charge on the first capacitor over time generates a detect signal representative of the electrical state of the pushbutton switch and the wire;
a signal monitoring circuit includes:
a signal receiving circuit electrically coupled to the input port of the processor, the signal receiving circuit having an input terminal electrically coupled to receive the detect signal, wherein the input port of the processor is electrically coupled to receive the detect signal, wherein the processor is adapted to monitor the detect signal to determine the electrical state of the pushbutton switch and the wire.

15. The apparatus according to claim 14:
wherein the electrical state of the pushbutton switch further comprises: normal operating states including an idle state and an active state and a failure state including a short circuit state, wherein the pushbutton switch is not actuated in the idle state, and wherein the pushbutton switch is momentarily actuated in the active state, wherein the pushbutton switch stays actuated in the short circuit state, and
wherein the electrical state of the wire further comprises failure states including an open circuit state and a short circuit state.

16. The apparatus according to claim 14 wherein the processor further comprises a bi-directional port including the output port of the processor and the input port of the processor, wherein the processor provides the digital pulse signal at the bidirectional port configured as the output port of the processor at a first predetermined time, and wherein the processor receives the detect signal at the bidirectional port configured as the input port of the processor at a second predetermined time after the first predetermined time.

17. The apparatus according to claim 14, further comprising:
a second capacitor having a first terminal and a second terminal, wherein the first terminal of the second capacitor is electrically coupled to the ground potential, wherein the second terminal of the second capacitor is electrically coupled to the output terminal of the signal generator to permit the second capacitor to be in parallel with the first capacitor, wherein the second terminal of the second capacitor is electrically coupled to receive the amplified digital pulse signal from the signal generator to change the electrical charge on the second capacitor, and wherein the change of the electrical charge on the first capacitor and the second capacitor over time generates the detect signal representative of the electrical state of the pushbutton switch and the wire, and
wherein the signal monitoring circuit is adapted to monitor the detect signal to determine the electrical state of the pushbutton switch and the wire.

18. A telematics communication system comprising:
a telematics control unit including:
a signal generator having an output terminal and adapted to generate a test signal at the output terminal, wherein the test signal is a digital pulse signal having a predetermined duration and a predetermined amplitude;
a wire having a predetermined length and including a first end and a second end, wherein the first end of the wire is electrically coupled to the output terminal of the signal generator and adapted to receive and carry the digital pulse signal;
a user interface being electrically coupled to the telematics control unit and located at a position remote from the telematics control unit, the user interface including:
a pushbutton switch assembly including:
a pushbutton switch having a first terminal and a second terminal, wherein the first terminal of the pushbutton switch is electrically coupled to a ground potential, and wherein the second terminal of the pushbutton switch is electrically coupled to the second end of the wire; and
a first capacitor having a first terminal and a second terminal, wherein the first terminal of the first capacitor is electrically coupled to the ground potential, wherein the second terminal of the first capacitor is electrically coupled to the second terminal of the pushbutton switch and electrically coupled to the second end of the wire, wherein the second terminal of the first capacitor is electrically coupled to receive the digital pulse signal from the wire to change an electrical charge on the first capacitor, and wherein the change of the electrical charge on the first capacitor over time generates a detect signal representative of the electrical state of the pushbutton switch and the wire;
wherein the telematics control unit further includes:
a signal monitoring circuit having an input terminal electrically coupled to receive the detect signal, wherein the signal monitoring circuit is adapted to monitor the detect signal to determine the electrical state of the pushbutton switch and the wire;
a transceiver being electrically coupled to the telematics control unit and the user interface, wherein the transceiver is adapted to generate a transmit signal responsive to the electrical state of the pushbutton switch; and
an antenna being electrically coupled to the transceiver and adapted to radiate the transmit signal.

19. The telematics communication system according to claim 18:
wherein the electrical state of the pushbutton switch further comprises: normal operating states including an idle state and an active state and a failure state including a short circuit state, wherein the pushbutton switch is not actuated in the idle state, and wherein the pushbutton switch is momentarily actuated in the active state causing the transmitter to generate the transmit signal, wherein the pushbutton switch stays actuated in the short circuit state, and
wherein the electrical state of the wire further comprises failure states including an open circuit state and a short circuit state.

20. The telematics communication system according to claim 18, wherein the signal generator further includes:
a processor having an output port and an input port, wherein the output port of the processor is adapted to provide the digital pulse signal; and
a signal amplifier having an input terminal and an output terminal, wherein the input terminal of the signal amplifier is electrically coupled to the output port of the processor to permit the signal amplifier to receive the digital pulse signal, wherein the output terminal of the signal amplifier is the output terminal of the signal generator, wherein the signal amplifier is adapted to amplify the digital pulse signal responsive to receiving the digital pulse signal at the input terminal of the signal amplifier to generate an amplified digital pulse signal at the output terminal of the signal amplifier.

21. The telematics communication system according to claim 20, wherein the processor further comprises a bidirectional port including the output port of the processor and the input port of the processor, wherein the processor provides the digital pulse signal at the bi-directional port configured as the output port of the processor at a first predetermined time, and wherein the processor receives the detect signal at the bidirectional port configured as the input port of the processor at a second predetermined time after the first predetermined time.

22. The telematics communication system according to claim 18, wherein the telematics control unit further comprises:
a second capacitor having a first terminal and a second terminal, wherein the first terminal of the second capacitor is electrically coupled to the ground potential, wherein the second terminal of the second capacitor is electrically coupled to the output terminal of the signal generator to permit the second capacitor to be in parallel with the first capacitor, wherein the second terminal of the second capacitor is electrically coupled to receive the amplified digital pulse signal from the signal generator to change the electrical charge on the second capacitor, and wherein the change of the electrical charge on the first capacitor and the second capacitor over time generates the detect signal representative of the electrical state of the pushbutton switch and the wire, and
wherein the signal monitoring circuit is adapted to monitor the detect signal to determine the electrical state of the pushbutton switch and the wire.

23. A pushbutton switch assembly comprising:
a pushbutton switch having a first terminal and a second terminal, wherein the first terminal of the pushbutton switch is adapted to be electrically coupled to a ground potential, and wherein the second terminal of the pushbutton switch is adapted to receive a test signal from an output terminal of a signal generator; and
a first capacitor having a first terminal and a second terminal, wherein the first terminal of the first capacitor is adapted to be electrically coupled to the ground potential, wherein the second terminal of the first capacitor is adapted to be electrically coupled to the second terminal of the pushbutton switch and adapted to be electrically coupled to the output terminal of the signal generator, wherein the second terminal of the first capacitor is adapted to receive the test signal from an output terminal of a signal generator to change an electrical charge on the first capacitor, and wherein the change of the electrical charge on the first capacitor over time generates a detect signal representative of the electrical state of the pushbutton switch,
wherein the second terminal of the first capacitor is adapted to be electrically coupled to a signal monitoring circuit having an input terminal electrically coupled to receive the detect signal, wherein the signal monitoring circuit is adapted to monitor the detect signal to determine the electrical state of the pushbutton switch.

24. The pushbutton switch assembly according to claim 23, wherein the electrical state of the pushbutton switch further comprises: normal operating states including an idle state and an active state and a failure state including a short circuit state, wherein the pushbutton switch is not actuated in the idle state, and wherein the pushbutton switch is momentarily actuated in the active state, wherein the pushbutton switch stays actuated in the short circuit state.

25. The pushbutton switch assembly according to claim 23, wherein the test signal is a digital pulse signal having a predetermined duration and a predetermined amplitude.

26. A telematics control unit comprising:
a signal generator having an output terminal and adapted to generate a test signal at the output terminal, wherein the signal generator is adapted to be electrically coupled to a pushbutton switch assembly including:
a pushbutton switch having a first terminal and a second terminal, wherein the first terminal of the pushbutton switch is adapted to be electrically coupled to a ground potential, and wherein the second terminal of the pushbutton switch is adapted to be electrically coupled to the output terminal of the signal generator; and
a first capacitor having a first terminal and a second terminal, wherein the first terminal of the first capacitor is adapted to be electrically coupled to the ground potential, wherein the second terminal of the first capacitor is adapted to be electrically coupled to the second terminal of the pushbutton switch and adapted to be electrically coupled to the output terminal of the signal generator, and wherein the second terminal of the first capacitor is adapted to be electrically coupled to receive the test signal to change an electrical charge on the first capacitor, and wherein the change of the electrical charge on the first capacitor over time generates a detect signal representative of the electrical state of the pushbutton switch;
wherein the telematics control unit further comprises:
a signal monitoring circuit having an input terminal electrically coupled to receive the detect signal, wherein the signal monitoring circuit is adapted to monitor the detect signal to determine the electrical state of the pushbutton switch.

27. The telematics control unit according to claim 26, wherein the electrical state of the pushbutton switch further comprises: normal operating states including an idle state and an active state and a failure state including a short circuit state, wherein the pushbutton switch is not actuated in the idle state, and wherein the pushbutton switch is momentarily actuated in the active state, wherein the pushbutton switch stays actuated in the short circuit state.

28. The telematics control unit according to claim 26, wherein the test signal is a digital pulse signal having a predetermined duration and a predetermined amplitude.

29. The telematics control unit according to claim 26, wherein the telematics control unit is adapted to be electrically coupled to a wire having a predetermined length and including a first end and a second end, wherein the first end of the wire is adapted to be electrically coupled to the output terminal of the signal generator and is adapted to receive and carry the test signal, wherein the second end of the wire is adapted to be electrically coupled to the second terminal of the first capacitor, and wherein the signal monitoring circuit is adapted to monitor the detect signal to determine the electrical state of the pushbutton switch and the wire.

30. The telematics control unit according to claim 29, wherein the electrical state of the wire further comprises failure states including an open circuit state and a short circuit state.

31. The telematics control unit according to claim 29, wherein the telematics control unit further comprises:
a second capacitor having a first terminal and a second terminal, wherein the first terminal of the second capacitor is adapted to be electrically coupled to the ground potential, wherein the second terminal of the second capacitor is adapted to be electrically coupled to the output terminal of the signal generator to permit the second capacitor to be in parallel with the first capacitor, wherein the second terminal of the second capacitor is adapted to be electrically coupled to receive the amplified digital pulse signal from the signal generator to change the electrical charge on the second capacitor, and wherein the change of the electrical charge on the first capacitor and the second capacitor over time generates the detect signal representative of the electrical state of the pushbutton switch and the wire, and
wherein the signal monitoring circuit is adapted to monitor the detect signal to determine the electrical state of the pushbutton switch and the wire.

32. The telematics control unit according to claim 26, wherein the signal generator further includes:
a processor having an output port and an input port, wherein the output port of the processor is adapted to provide the test signal; and
a signal amplifier having an input terminal and an output terminal, wherein the input terminal of the signal amplifier is adapted to be electrically coupled to the output port of the processor to permit the signal amplifier to receive the test signal, wherein the output terminal of the signal amplifier is the output terminal of the signal generator, wherein the signal amplifier is adapted to amplify the test signal responsive to receiving the test signal at the input terminal of the signal amplifier to generate an amplified test signal at the output terminal of the signal amplifier.

33. The apparatus according to claim 32 wherein the processor further comprises a bidirectional port including the output port of the processor and the input port of the processor, wherein the processor provides the digital pulse signal at the bi-directional port configured as the output port of the processor at a first predetermined time, and wherein the processor is adapted to receive the detect signal at the bidirectional port configured as the input port of the processor at a second predetermined time after the first predetermined time.

34. A method for determining an electrical state of a pushbutton switch in an electronic system, the method comprising the steps of:
generating a test signal;
receiving the test signal by the first capacitor electrically coupled in parallel to a pushbutton switch to change an electrical charge on the first capacitor;
generating a detect signal, representative of the electrical state of the pushbutton switch, responsive to a change of the electrical charge on the first capacitor over time; and
monitoring the detect signal to determine the electrical state of the pushbutton switch.

35. The method according to claim 34, wherein the electrical state of the pushbutton switch further comprises: normal operating states including an idle state and an active state and a failure state including a short circuit state, wherein the pushbutton switch is not actuated in the idle state, and wherein the pushbutton switch is momentarily actuated in the active state, wherein the pushbutton switch stays actuated in the short circuit state.

36. The method according to claim 34, wherein the test signal is a digital pulse signal having a predetermined duration and a predetermined amplitude.

37. The method according to claim 34 further comprising the step of:
amplifying the test signal to generate an amplified test signal responsive to the step of generating the test signal.

38. The method according to claim 34 wherein the step of monitoring further comprises the steps of:
determining that the test signal has stopped;
determining that a first predetermined period of time has lapsed responsive to the step of determining that the test signal has stopped;
determining an amplitude of the detect signal responsive to the step of determining that the first predetermined period of time has lapsed;
determining that the amplitude of the detect signal is within a first predetermined amplitude range responsive to the step of determining an amplitude of the detect signal; and
determining that the electrical state of the pushbutton switch is in an idle state, indicative of the pushbutton switch not being actuated, responsive to the step of determining that the amplitude of the detect signal is within the first predetermined amplitude range.

39. The method according to claim 38 wherein the step of monitoring further comprises the steps of:
determining that a second predetermined period of time, longer than the first predetermined period of time, has lapsed responsive to the step of determining that the amplitude of the detect signal is not within the first predetermined amplitude range;
determining the amplitude of the detect signal responsive to the step of determining that the second predetermined period of time has lapsed;
determining that the amplitude of the detect signal is within a second predetermined amplitude range, greater than the first predetermined amplitude range, responsive to the step of determining the amplitude of the detect signal; and
determining that the electrical state of the pushbutton switch is in an open circuit state, indicative of an open circuit in a wire electrically coupled to the pushbutton switch, responsive to the step of determining that the amplitude of the detect signal is within the second predetermined amplitude range.

40. The method according to claim 39 wherein the step of monitoring further comprises the steps of:
determining that a third predetermined period of time, longer than the second predetermined period of time, has lapsed responsive to the step of determining that the amplitude of the detect signal is not within the second predetermined amplitude range;
determining the amplitude of the detect signal responsive to the step of determining that the third predetermined period of time has lapsed;
determining that the amplitude of the detect signal is within the second predetermined amplitude range responsive to the step of determining the amplitude of the detect signal; and
determining that the electrical state of the pushbutton switch is in an active state, indicative of the pushbutton switch being momentarily actuated, responsive to the step of determining that the amplitude of the detect signal is within the second predetermined amplitude range.

41. The method according to claim 39 wherein the step of monitoring further comprises the steps of:
determining that a third predetermined period of time, longer than the second predetermined period of time, has lapsed responsive to the step of determining that the amplitude of the detect signal is not within the second predetermined amplitude range;
determining the amplitude of the detect signal responsive to the step of determining that the third predetermined period of time has lapsed;
determining that the amplitude of the detect signal is not within the second predetermined amplitude range responsive to the step of determining the amplitude of the detect signal; and
determining that the electrical state of the pushbutton switch is in a short circuit state, indicative of the pushbutton switch staying actuated, responsive to the step of determining that the amplitude of the detect signal is not within the second predetermined amplitude range.

42. An apparatus for determining an electrical state of a pushbutton switch in an electronic system, the apparatus comprising:
a signal generator adapted to generate a test signal;
a pushbutton switch assembly including:
a pushbutton switch; and
an energy storage device electrically coupled to the pushbutton switch and adapted to receive the test signal to permit energy to be change an electrical charge on the energy storage device, wherein the change of the electrical charge on the energy storage device over time generates a detect signal representative of the electrical state of the pushbutton switch; and
a signal monitoring circuit having an input terminal electrically coupled to receive the detect signal, wherein the signal monitoring circuit is adapted to monitor the detect signal to determine the electrical state of the pushbutton switch.

43. The apparatus according to claim 42 wherein the energy storage device is a capacitor.

44. The apparatus according to claim 42 wherein the energy storage device is an inductor.
